(19) United States
(12) Patent Application Publication
(10) Pub. No.: US 2020/0034942 A1
(43) Pub. Date: Jan. 30, 2020

(54) VEHICLE DISPATCHING SYSTEM

(71) Applicant: TOYOTA JIDOSHA KABUSHIKI KAISHA, Toyota-shi (JP)

(72) Inventor: Tatsuya SUGANO, Susono-shi (JP)

(73) Assignee: TOYOTA JIDOSHA KABUSHIKI KAISHA, Toyota-shi (JP)

(21) Appl. No.: 16/524,340

(22) Filed: Jul. 29, 2019

(30) Foreign Application Priority Data
Jul. 30, 2018 (JP) 2018-142646

(51) Int. Cl. G06Q 50/30; G06Q 10/10

(52) U.S. Cl. CPC G06Q 50/30; G06Q 10/1093

(57) ABSTRACT

A vehicle dispatching system is configured to dispatch a vehicle to a user by automated driving. The vehicle dispatching system is provided with: a first acquirer configured to obtain vehicle dispatch request information including a preferred pickup location, which is designated by the user as a boarding location of the vehicle; a determinator configured to determine whether or not the user is in a misrecognition state in which the user possibly waits for the vehicle in a location that is different from the preferred pickup location; and a notifier configured to notify the user of the misrecognition state if it is determined that the user is in the misrecognition state.

### CROSS-REFERENCE TO RELATED APPLICATIONS

This application is based upon and claims the benefit of priority of the prior Japanese Patent Application No. 2018-142646, filed on Jul. 30, 2018, the entire contents of which are incorporated herein by reference.

### BACKGROUND

### 1. Technical Field

Embodiments of the present disclosure relate to a vehicle dispatching system configured to dispatch a vehicle by automated driving.

### 2. Description of the Related Art

For this type of system, there is known a system for dispatching a vehicle to a place designated by a user, by automated driving. For example, Japanese Patent Application Laid Open No. 2015-176468 (Patent Literature 1) discloses a technology/technique in which a vehicle in a parking lot is automatically driven to a predetermined boarding location or a pickup location by a departure schedule time point designated by the user. The specification of U.S. Patent Publication No. 2016/0362103 (Patent Literature 2) discloses a technology/technique in which a vehicle abandoned or left by a user is automatically moved to and parked in a parking space, and in which the user can be picked up in a designated location on a track to the parking space. Japanese Patent Application Laid Open No. 2016-091411 (Patent Literature 3) discloses a technology/technique in which a vehicle dispatch location is determined from a user's current position or the like and in which a communication terminal owned by the user is notified of a route from a current location to a boarding location.

Presumably, depending on circumstances, a vehicle cannot be dispatched to a boarding location desired or preferred by a user. Thus, in Japanese Patent Application Laid Open No. 2009-204457 (Patent Literature 4), there is proposed a technology/technique in which if it is determined that a vehicle cannot reach a boarding location, a user is notified of a new meeting place and a position of the vehicle.

If the user designates the boarding location (in other words, the vehicle dispatch location), the user's misunderstanding may cause such a situation that the vehicle is not dispatched to the user. For example, if the user misunderstands and keeps waiting for the vehicle in a different location from the designated boarding location, the vehicle is not dispatched to the user even through the vehicle is correctly dispatched to the designated boarding location. Such user's misunderstanding is not considered at all in the Patent Literature 4, and it is hard to solve the aforementioned situation when it occurs. In other words, such a situation is hardly determined to be abnormal, because the dispatch of the vehicle is correctly completed. As a result, it is hard to avoid an unnecessary waiting time.

### SUMMARY

In view of the aforementioned problems, it is therefore an object of embodiments of the present disclosure to provide a vehicle dispatching system that can reduce the unnecessary waiting time caused by the user's misunderstanding.

An aspect of the vehicle dispatching system according to the present disclosure is a vehicle dispatching system configured to dispatch a vehicle to a user by automated driving, the vehicle dispatching system provided with: a first acquirer configured to obtain vehicle dispatch request information including a preferred pickup location, which is designated by the user as a boarding location of the vehicle; a determinator configured to determine whether or not the user is in a misrecognition state in which the user possibly waits for the vehicle in a location that is different from the preferred pickup location; and a notifier configured to notify the user of the misrecognition state if it is determined that the user is in the misrecognition state.

### DETAILED DESCRIPTION OF THE EMBODIMENTS

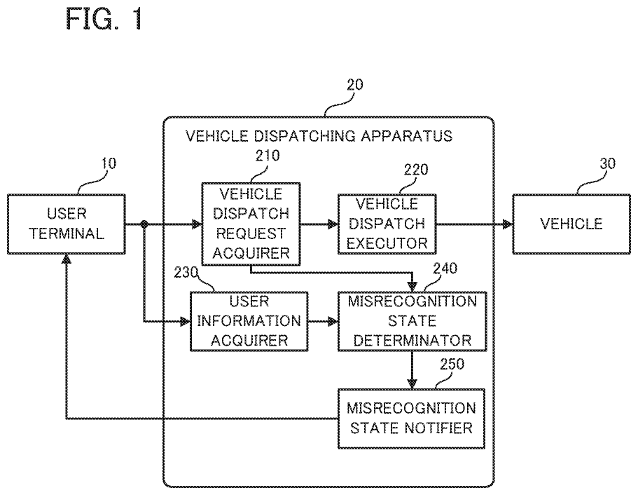

FIG. 1 is a block diagram illustrating a configuration of a vehicle dispatching system according to a first embodiment;

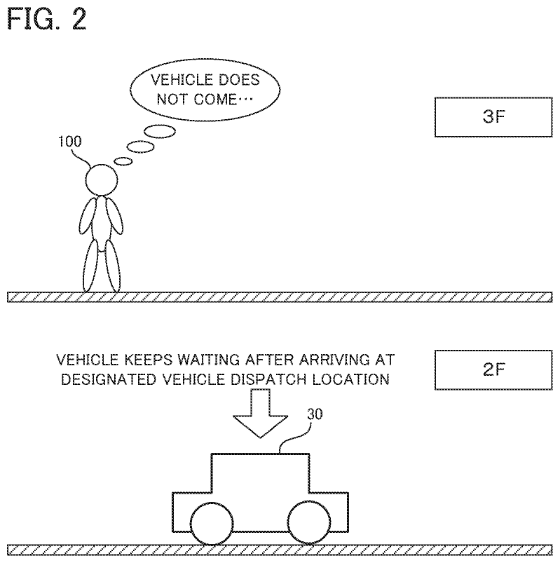

FIG. 2 is a conceptual diagram illustrating a technical problem that can occur due to a user's misunderstanding;

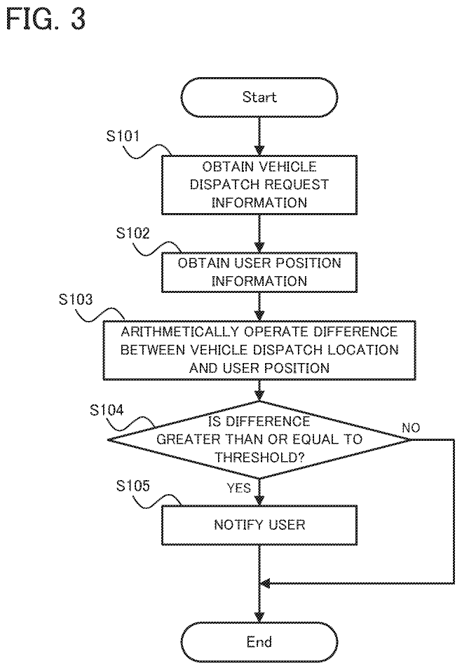

FIG. 3 is a flowchart illustrating a flow of operations of the vehicle dispatching system according to the first embodiment;

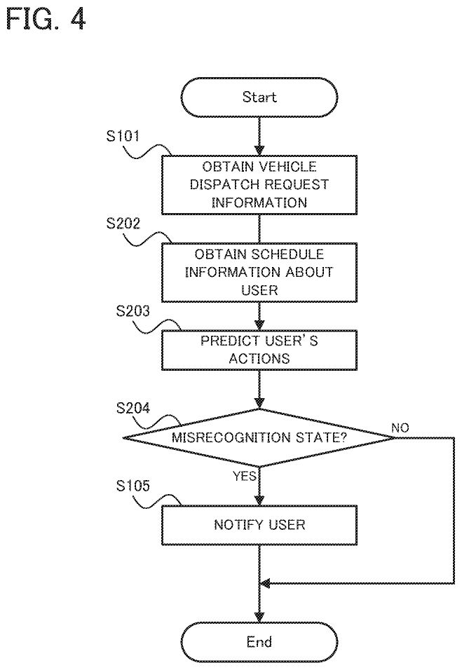

FIG. 4 is a flowchart illustrating a flow of operations of a vehicle dispatching system according to a second embodiment; and

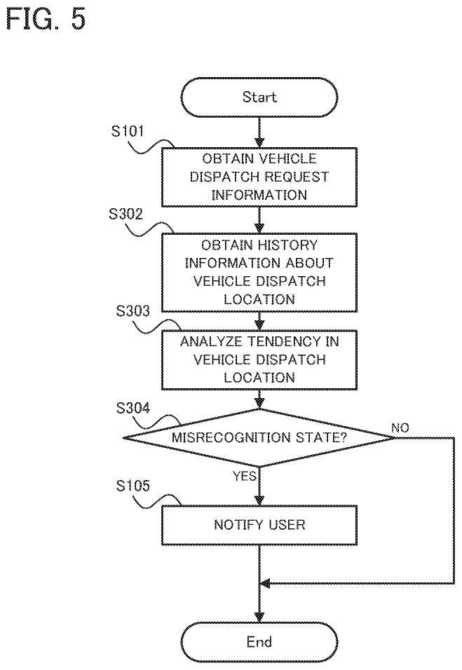

FIG. 5 is a flowchart illustrating a flow of operations of a vehicle dispatching system according to a third embodiment.

### DETAILED DESCRIPTION OF THE EMBODIMENT

Hereinafter, vehicle dispatching systems according to embodiments will be explained with the drawings.

### First Embodiment

A vehicle dispatching system according to a first embodiment will be explained with reference to FIG. 1 to FIG. 3.

(System Configuration)

Firstly, a configuration of the vehicle dispatching system according to the first embodiment will be explained with reference to FIG. 1. FIG. 1 is a block diagram illustrating the configuration of the vehicle dispatching system according to the first embodiment.

As illustrated in FIG. 1, the vehicle dispatching system according to the first embodiment is provided with a user terminal 10, a vehicle dispatching apparatus 20, and a vehicle. The vehicle dispatching system is configured to dispatch a vehicle 30 to a user in accordance with a vehicle dispatch request, which is outputted from the user terminal 10 to the vehicle dispatching apparatus 20. In the configuration illustrated in FIG. 1, for convenience of explanation, only one user terminal 10 and one vehicle 30 are illustrated, but a plurality of user terminals 10 and a plurality of vehicles 30 may correspond to one vehicle dispatching apparatus 20.

The user terminal 10 may be a mobile terminal (e.g., a smart phone, an exclusive terminal, etc.) owned by the user, and is configured to make a vehicle dispatch request (specifically, to transmit vehicle dispatch request information) to the vehicle dispatching apparatus 20 in accordance with the user's operation. Moreover, the user terminal 10 is configured to transmit various information (e.g., information about a position of the user, etc.) other than the vehicle dispatch request information, to the vehicle dispatching apparatus 20. The user terminal 10 is further configured to notify the user of information received from the vehicle dispatching apparatus 20.

The vehicle dispatching apparatus 20 may be an apparatus configured to manage the dispatch of the vehicle to the user, and may be provided, for example, in a parking lot in which automatic parking can be performed, or the like. Alternatively, the vehicle dispatching apparatus 20 may be mounted or installed inside the user terminal 10 or the vehicle 30. The vehicle dispatching apparatus 20 is provided with a vehicle dispatch request acquirer 210, a vehicle dispatch executor 220, a user information acquirer 230, a misrecognition state determinator 240, and a misrecognition state notifier 250, as processing blocks or physical processing circuits for realizing its function.

The vehicle dispatch request acquirer 210 is configured to obtain the vehicle dispatch request information from the user terminal 10. The vehicle dispatch request information may include at least information about a vehicle dispatch location (in other words, a preferred pickup location of the user). The vehicle dispatch request information obtained by the vehicle dispatch request acquirer 210 may be outputted to each of the vehicle dispatch executor 220 and the misrecognition state determinator 240. The vehicle dispatch request acquirer 210 is a specific example of the “first acquirer” in Supplementary Notes described later.

The vehicle dispatch executor 220 is configured to output a vehicle dispatch command to the vehicle 30, on the basis of the vehicle dispatch request information obtained by the vehicle dispatch request acquirer 210. Specifically, the vehicle dispatch executor 220 may output a command to the vehicle 30 corresponding to the user who has made the vehicle dispatch request, so as to move to the vehicle dispatch location designated by the user. If the vehicle dispatch request information includes information about a vehicle dispatch time, the vehicle dispatch executor 220 may output such a command that the vehicle arrives at the vehicle dispatch location at a vehicle dispatch time point.

The user information acquirer 230 is configured to obtain information other than the vehicle dispatch request information (hereinafter referred to as “user information” as occasion demands), from the user terminal 10. The user information acquirer 230 according to the first embodiment is particularly configured to obtain position information indicating the position of the user, as the user information. The user information obtained by the user information acquirer 230 may be outputted to the misrecognition state determinator 240. The user information acquirer 230 is a specific example of the “second acquirer” in Supplementary Notes described later.

The misrecognition state determinator 240 is configured to determine whether or not the user is in a “misrecognition state” in which the user is possibly misunderstanding the vehicle dispatch location, on the basis of the vehicle dispatch request information obtained by the vehicle dispatch request acquirer 210 and the user information obtained by the user information acquirer 230. In other words, the misrecognition state determinator 240 is configured to determine whether or not there is a possibility of a deviation between the vehicle dispatch location intended by the user (in other words, a position at which the user waits for the vehicle 30) and the vehicle dispatch location included in the vehicle dispatch request information (in other words, a position in which the vehicle 30 is actually dispatched). A specific method of determining the misrecognition state performed by the misrecognition state determinator 240 will be described later. A result of the determination by the misrecognition state determinator 240 may be outputted to the misrecognition state notifier 250. The misrecognition state determinator 240 is a specific example of the “determinator” in Supplementary Notes described later.

The misrecognition state notifier 250 is configured to output information indicating the result of the determination by the misrecognition state determinator 240 if it is determined by the misrecognition state determinator 240 that the user is “in the misrecognition state”. By this, an owner of the user terminal 10 (i.e., the user) may recognize that the user is in the misrecognition state, i.e., that the user is possibly misunderstanding the vehicle dispatch location. The misrecognition state notifier 250 is a specific example of the “notifier” in Supplementary Notes described later.

The vehicle 30 is configured to perform automated driving (i.e., driving without a driver), and is configured to autonomously move to the designated vehicle dispatch location, in accordance with the vehicle dispatch command from the vehicle dispatching apparatus 20. The automated driving of the vehicle 30 may be realized not only by the driving of the vehicle 30 itself, but also by, for example, a belt conveyor provided in a parking facility or the like. The vehicle 30 that is completely dispatched keeps waiting in the vehicle dispatch location until the user gets on the vehicle 30.

(Technical Problem that can Occur in Dispatch of Vehicle)

Next, technical problems that can occur in the dispatch of the vehicle will be specifically explained with reference to FIG. 2. FIG. 2 is a conceptual diagram illustrating a technical problem that can occur due to the user's misunderstanding.

In an example illustrated in FIG. 2, a user 100 requests the dispatch of the vehicle 30 in a multistory parking space and waits for the arrival of the vehicle 30. Here, in particular, the user 100 thinks that the user 100 has designated the third floor of the multistory parking space as the vehicle dispatch location. However, the second floor of the multistory parking space is actually designated as the vehicle dispatch location, and the vehicle 30 keeps waiting in the dispatch location on the second floor. This type of misunderstanding can easily occur, for example, due to an operation error of the user terminal 10 by the user 100 (specifically, erroneously pressing a button, etc.) or a special environment having a similar view like the multistory parking space.

If the user is misunderstanding the vehicle dispatch location, the vehicle 30 will never arrive at the user 100 even though the vehicle 30 is correctly dispatched to the designated vehicle dispatch location. In other words, the user 100 and the vehicle 30 keep waiting in different locations. Such a situation is hardly determined to be abnormal because the dispatch of the vehicle is correctly completed, and it likely continues until the user 100 notices his or her misunderstanding. In other words, the misunderstanding by the user 100 likely causes a waiting time that is originally unnecessary.

The vehicle dispatching system according to the first embodiment is configured to perform operations described later, so as to solve the technical problem caused by the misunderstanding by the user 100 as described above.

(Explanation of Operations)

A flow of operations of the vehicle dispatching system according to the first embodiment will be explained with reference to FIG. 3. FIG. 3 is a flowchart illustrating the flow of the operations of the vehicle dispatching system according to the first embodiment.

As illustrated in FIG. 3, in operation of the vehicle dispatching system according to the first embodiment, firstly, the vehicle dispatch request acquirer 210 obtains the vehicle dispatch request information transmitted from the user terminal 10 (step S101). The dispatch of the vehicle corresponding to the vehicle dispatch request may be performed immediately after the acquisition of the vehicle dispatch request information, or may be performed after the determination of the misrecognition state described later.

The user information acquirer 230 then obtains the position information of the user 100 (step S102). The position information of the user 100 may be obtained, for example, by using a global positioning system (GPS) of the user terminal 10 or the like. If the stories of a building need to be distinguished, as illustrated in FIG. 2, the position information may be obtained by using a position information acquisition system provided in a facility, or the like.

The misrecognition state determinator 240 then arithmetically operates a difference between the vehicle dispatch location included in the vehicle dispatch request information (i.e., the location designated by the user) and the position indicated by the position information about the user 100 (hereinafter referred to as a “user position” as occasion demands) (step S103). The difference herein may be calculated as a distance between the vehicle dispatch location and the user position, or may be calculated as a value indicating a transit time in which a moving speed (e.g., a walking speed) of the user 100 is considered for the distance between the vehicle dispatch location and the user position.

The misrecognition state determinator 240 then determines whether or not the calculated difference is greater than or equal to a predetermined threshold value (step S104). The threshold value herein may be set as a value that is large enough to determine that the user is misunderstanding the vehicle dispatch location, and an optimum value may be determined in advance by prior simulations or the like. For example, the threshold value may be set as a value that allows the determination that it takes an unrealistically long time for the user to move from a current position to the vehicle dispatch location.

The threshold value may be also set variable depending on situations. For example, in a situation in which a designated vehicle dispatch time point is designated in the vehicle dispatch request, suppose that the user 100 has an enough time at a current time point before the designated vehicle dispatch time point and that it is before the dispatch of the vehicle 30 is actually started (e.g., if it is before the vehicle 30 starts to leave from a parking space or a waiting place). In this case, even if the user position is significantly far from the vehicle dispatch location, the user 100 may arrive at the vehicle dispatch location later (i.e., the user 100 may not be making a mistake) at the vehicle dispatch time point. In this situation, a relatively large threshold value is preferably used. On the other hand, suppose that it is already at or after the vehicle dispatch time point and the vehicle 30 has already arrived at the vehicle dispatch location. In this case, even if the user position is relatively close to the vehicle dispatch location, the user 100 less likely arrives at the vehicle dispatch location later (i.e., the user 100 is likely making a mistake and thus does not move the place and does not arrive at the vehicle dispatch location). In this situation, a relatively small threshold value is preferably used.

As described above, by determining whether or not the difference is greater than or equal to the predetermined threshold value, it is possible to accurately determine whether or not the user 100 is in the misrecognition state. Thus, if it is determined that the difference is greater than or equal to the predetermined threshold value (the step S104: YES), the misrecognition state notifier 250 notifies the user terminal 10 that the user 100 is in the misrecognition state (step S105). Specifically, a notification is sent by audio output, image output, vibration output, or the like, from the user terminal 10. If it is determined that the difference is not greater than or equal to the predetermined threshold value (the step S104: NO), the aforementioned notification is not sent.

The vehicle dispatching system may perform a process of automatically changing the vehicle dispatch location (e.g., setting a location close to the current user position, as a new vehicle dispatch location) after notifying the user 100 of the misrecognition state.

(Technical Effect)

Next, a technical effect obtained by the vehicle dispatching system according to the first embodiment will be explained.

As illustrated in FIG. 1 to FIG. 3, in the vehicle dispatching system according to the first embodiment, it is possible to determine that the user 100 is in the misrecognition state from the position information about the user 100 and to notify the user 100 of the misrecognition state. The user 100 who receives the notification can recognize that the user 100 is in the misrecognition state (i.e., that the user 100 is possibly misunderstanding the vehicle dispatch location). Thus, even in the case of misunderstanding, it is possible to avoid a situation in which the user 100 keeps waiting for the vehicle 30 at the wrong vehicle dispatch location. It is thus possible to effectively reduce the unnecessary waiting time in the dispatch of the vehicle.

### Second Embodiment

Next, a vehicle dispatching system according to a second embodiment will be explained. The second embodiment is partially different in the operations from the first embodiment already explained, but is substantially the same in the other part. Thus, hereinafter, a detailed explanation will be given to the different part from that of the first embodiment, and an explanation will be omitted for the other same part.

(Explanation of Operation)

A flow of operations of the vehicle dispatching system according to the second embodiment will be explained with reference to FIG. 4. FIG. 4 is a flowchart illustrating the flow of the operations of the vehicle dispatching system according to the second embodiment.

As illustrated in FIG. 4, in operation of the vehicle dispatching system according to the second embodiment, as in the first embodiment, the vehicle dispatch request acquirer 210 obtains the vehicle dispatch request information (the step S101). Then, the user information acquirer 230 obtains schedule information about the user 100 (step S202). In other words, the user information acquirer 230 may function as a specific example of the “third acquirer” in Supplementary Notes described later.

The schedule information may be information about plans and reservation for the user 100, and may include information about a place and a time point for the user 100 to visit. More specifically, the schedule information may include, for example, information about reservation for an airport, a railroad, a hospital, a restaurant, or the like for the user 100, and information about future plans, such as the user 100 visiting or arriving in a predetermined place. The schedule information about the user 100 can use, for example, information stored in an application within the user terminal 10, or the like.

The misrecognition state determinator 240 according to the second embodiment predicts future actions of the user 100 by using the aforementioned schedule information (step S203). For example, if the user 100 reserves a restaurant for 12:00 on a day, the misrecognition state determinator 240 can predict that the user 100 will be near the restaurant around 12:00. As described above, if the schedule information is used, it is possible to estimate the user position without obtaining the position information about the user. Moreover, not only the user position at the current time point but also the user position in the future (i.e., at a time corresponding to the schedule) can be estimated. To use the schedule information as described above, it is desirable that the vehicle dispatch request information includes information about the vehicle dispatch time point.

The misrecognition state determinator 240 determines whether or not the user 100 is in the misrecognition state by using the user position estimated in the above manner (step S204). For example, as in the first embodiment, a difference between the estimated user position and the vehicle dispatch location may be arithmetically operated, and depending on whether or not the difference is greater than or equal to a threshold value, it may be determined whether or not the user 100 is in the misrecognition state.

If it is determined by the misrecognition state determinator 240 that the user 100 is in the misrecognition state (the step S204: YES), the misrecognition state notifier 250 notifies the user terminal 10 that the user 100 is in the misrecognition state (the step S105). On the other hand, if it is determined that the user 100 is not in the misrecognition state (the step S204: NO), the aforementioned notification is not sent.

(Technical Effect)

Next, a technical effect obtained by the vehicle dispatching system according to the second embodiment will be explained.

As illustrated in FIG. 4, in the vehicle dispatching system according to the second embodiment, it is possible to determine that the user 100 is in the misrecognition state by using the schedule information about the user 100 and to notify the user 100 of the misrecognition state. It is therefore possible to effectively reduce the unnecessary waiting time in the dispatch of the vehicle, as in the first embodiment already explained.

### Third Embodiment

Next, a vehicle dispatching system according to a third embodiment will be explained. The third embodiment is partially different in the operations from the first and second embodiments already explained, but is substantially the same in the other part. Thus, hereinafter, a detailed explanation will be given to the different part from those of the first and second embodiments, and an explanation will be omitted for the other same part.

(Explanation of Operation)

A flow of operations of the vehicle dispatching system according to the third embodiment will be explained with reference to FIG. 5. FIG. 5 is a flowchart illustrating the flow of the operations of the vehicle dispatching system according to the third embodiment.

As illustrated in FIG. 5, in operation of the vehicle dispatching system according to the third embodiment, as in the first embodiment, the vehicle dispatch request acquirer 210 obtains the vehicle dispatch request information (the step S101). Then, the user information acquirer 230 obtains history information about the vehicle dispatch location (i.e., the designated preferred pickup location) (step S302). The user information acquirer 230 according to the third embodiment may function as a specific example of the “fourth acquirer” in Supplementary Notes described later.

The history information may include information about past vehicle dispatch locations. More specifically, the history information may include information about locations designated as the vehicle dispatch locations in the past by the user 100 who requests the dispatch of the vehicle, and information about locations designated as the vehicle dispatch locations in the past by another user (i.e., a user who is different from the user 100 who requests the dispatch of the vehicle), or the like.

The misrecognition state determinator 240 according to the third embodiment analyzes a tendency in the location designated as the vehicle dispatch location, by using the aforementioned history information (step S303). Specifically, the misrecognition state determinator 240 may analyze a tendency in the vehicle dispatch location preferably used by the user 100, from the vehicle dispatch locations designated by the user 100 in the past. Alternatively, from the vehicle dispatch location used by another user when visiting a facility that the user 100 currently is visiting, the misrecognition state determinator 240 may analyze a tendency in the vehicle dispatch location preferably used by a user of the facility.

The misrecognition state determinator 240 determines whether or not the user 100 is in the misrecognition state by using a result of the analysis described above (step S304). For example, if the user 100, who tends to preferably use the same vehicle dispatch location, designates a vehicle dispatch location that is different from the usual, it may be determined that the user 100 is possibly making a mistake. Moreover, if there is a vehicle dispatch location that is frequently used by many users and if a location different from the vehicle dispatch location is designated by the user 100 as the vehicle dispatch location, it may be determined that the user 100 is possibly making a mistake. Moreover, if a location that is not desired by most users as the vehicle dispatch location is designated by the user 100 as the vehicle dispatch location, it may be determined that the user 100 is possibly making a mistake.

If it is determined by the misrecognition state determinator 240 that the user 100 is in the misrecognition state (the step S304: YES), the misrecognition state notifier 250 notifies the user terminal 10 that the user 100 is in the misrecognition state (the step S105). On the other hand, if it is determined that the user 100 is not in the misrecognition state (the step S304: NO), the aforementioned notification is not sent.

(Technical Effect)

Next, a technical effect obtained by the vehicle dispatching system according to the third embodiment will be explained.

As illustrated in FIG. 5, in the vehicle dispatching system according to the third embodiment, it is possible to determine that the user 100 is in the misrecognition state by using the history information about the past vehicle dispatch locations and to notify the user 100 of the misrecognition state. It is therefore possible to effectively reduce the unnecessary waiting time in the dispatch of the vehicle, as in the first and second embodiments already explained.

### Other Modified Examples

Next, an explanation will be given to modified examples of the vehicle dispatching system (specifically, modified examples of the method of determining the misrecognition state), which are different from the first to third embodiments described above.

The misrecognition state determinator 240 may determine whether or not the user 100 is in the misrecognition state, on the basis of entering/leaving information about the user 100. For example, if it is possible to specify a gate passed by the user 100 using his or her identification (ID) (specifically, if it is possible to specify a gate passed by showing or holding an employee ID card, an IC card ticket, or the like), the position of the gate passed by the user 100 can be obtained as the user position. Thus, if the difference between user position and the vehicle dispatch location is used as in the first embodiment, the misrecognition state can be accurately determined.

If the vehicle dispatching system is applied to a parking lot, the misrecognition state determinator 240 may determine whether or not the user 100 is in the misrecognition state, by using information about a parking route in the dispatch of the vehicle 30 that is parked. In some parking lot, it may be desirable to designate a point included in the parking route (i.e., a route that has passed in parking), as the vehicle dispatch location. Thus, if a location that is not included in the parking route is designated as the vehicle dispatch location, it can be determined that the user is possibly making a mistake.

The misrecognition state determinator 240 may determine whether or not the user 100 is in the misrecognition state, by using information about a leaving location in which the vehicle 30 is abandoned or left. In some facility (e.g., a parking lot, a hotel, etc.), the leaving location (e.g., a location in which the user gets off the vehicle 30) may be the same as the vehicle dispatch location (i.e., a location in which the user gets on the vehicle 30). Specifically, there are parking lots in which a space for getting on/off is determined in advance. In such parking lots, if a location that is different from the leaving location is designated as the vehicle dispatch location, it can be determined that the user 100 is making a mistake.

The misrecognition state determinator 240 may determine whether or not the user 100 is in the misrecognition state, on the basis of position information about a plurality of occupants of the vehicle 30. If there are occupants in the vehicle 30, the occupants are expected to gather in the vehicle dispatch location in the dispatch of the vehicle. Thus, if the occupants who will get on the vehicle 30 can be specified, it can be determined whether or not they are in the misrecognition state by using their respective position information. Specifically, if the occupants go to different locations or if at least one of the occupants goes to a different location from the other occupants, it can be determined that there is some misunderstanding.

<Supplementary Notes>

Various aspects of embodiments of the present disclosure derived from the embodiments explained above will be explained hereinafter.

(Supplementary Note 1)

A vehicle dispatching system described in Supplementary Note 1 is a vehicle dispatching system configured to dispatch a vehicle to a user by automated driving, the vehicle dispatching system provided with: a first acquirer configured to obtain vehicle dispatch request information including a preferred pickup location, which is designated by the user as a boarding location of the vehicle; a determinator configured to determine whether or not the user is in a misrecognition state in which the user possibly waits for the vehicle in a location that is different from the preferred pickup location; and a notifier configured to notify the user of the misrecognition state if it is determined that the user is in the misrecognition state.

According to the vehicle dispatching system described in Supplementary Note 1, the user is notified if the user misunderstands and possibly waits for the vehicle in the location that is different from the designated preferred pickup location. By this, the user can recognize that the user is making a mistake (specifically, that the user is misunderstanding the preferred pickup location). The user who recognizes the misrecognition state can avoid waiting in the location that is different from the preferred pickup location (i.e., a location to which the vehicle is dispatched). It is therefore possible to reduce the unnecessary waiting time caused by the user's misunderstanding.

(Supplementary Note 2)

A vehicle dispatching system described in Supplementary Note 2 is further provided with: a second acquirer configured to obtain position information indicating a position of the user, wherein the determinator is configured to determine whether or not the user is in the misrecognition state by using the vehicle dispatch request information and the position information.

According to the vehicle dispatching system described in Supplementary Note 2, it is possible to accurately determine that the user is in the misrecognition state, for example, on the basis of a difference between the user position and the preferred pickup location.

(Supplementary Note 3)

A vehicle dispatching system described in Supplementary Note 3 is further provided with: a third acquirer configured to obtain schedule information about the user, wherein the determinator is configured to determine whether or not the user is in the misrecognition state by using the vehicle dispatch request information and the schedule information.

According to the vehicle dispatching system described in Supplementary Note 3, it is possible to predict the user's actions (e.g., a place the user supposedly goes to from now, etc.), by using the schedule information about the user's planes and reservation. It is thus possible to accurately determine that the user is in the misrecognition state, on the basis of a deviation extent between the user's actions and the preferred pickup location, or the like.

(Supplementary Note 4)

A vehicle dispatching system described in Supplementary Note 4 is further provided with: a fourth acquirer configured to obtain history information about past preferred pickup locations, wherein the determinator is configured to determine whether or not the user is in the misrecognition state by using the vehicle dispatch request information and the history information.

According to the vehicle dispatching system described in Supplementary Note 4, the misrecognition state may be determined by using the history information about the past preferred pickup locations (which may include information about another user). For example, if it is requested to dispatch a vehicle to a place that is never designated as the preferred pickup location before, then, it can be determined that the user is likely making a mistake (i.e., that the user is in the misrecognition state).

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A vehicle dispatching system configured to dispatch a vehicle to a user by automated driving, said vehicle dispatching system comprising:
a first acquirer configured to obtain vehicle dispatch request information including a preferred pickup location, which is designated by the user as a boarding location of the vehicle;
a determinator configured to determine whether or not the user is in a misrecognition state in which the user possibly waits for the vehicle in a location that is different from the preferred pickup location; and
a notifier configured to notify the user of the misrecognition state if it is determined that the user is in the misrecognition state.

2. The vehicle dispatching system according to claim 1, further comprising: a second acquirer configured to obtain position information indicating a position of the user, wherein
said determinator is configured to determine whether or not the user is in the misrecognition state by using the vehicle dispatch request information and the position information.

3. The vehicle dispatching system according to claim 1, further comprising: a third acquirer configured to obtain schedule information about the user, wherein
said determinator is configured to determine whether or not the user is in the misrecognition state by using the vehicle dispatch request information and the schedule information.

4. The vehicle dispatching system according to claim 1, further comprising: a fourth acquirer configured to obtain history information about past preferred pickup locations, wherein
said determinator is configured to determine whether or not the user is in the misrecognition state by using the vehicle dispatch request information and the history information.
